(19) United States
(12) Patent Application Publication
(10) Pub. No.: US 2009/0165433 A1
(43) Pub. Date: Jul. 2, 2009

(54) Method and Apparatus for Harvesting Standing Vegetable Crops

(75) Inventors: James Phillip Jauncey, Queensland (AU); Phillip Rigby Jauncey, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(73) Assignee: MATILDA FRESH FOODS PTY LTD, Brookstead (AU)

(21) Appl. No.: 12/225,108

(22) PCT Filed: Mar. 13, 2007
(86) PCT No.: PCT/AU2007/000307

§ 371 Date: Sep. 15, 2008

(30) Foreign Application Priority Data
Mar. 13, 2006 (AU) 2006901254

(51) Int. Cl. A01D 45/00; A01D 45/26

(52) U.S. Cl. 56/14.5; 56/327.1

(57) ABSTRACT

Apparatus for harvesting broccoli or other standing vegetable plants comprising a mobile frame (11) adapted to be advanced along a row of plants to be harvested, a harvesting head (15) for gripping the stems of respective plants in turn as the mobile frame is advanced along the row and for conveying the gripped stems of plants rearwardly relative to the direction of movement of the mobile frame, a stem severing mechanism (19) for severing the stems of plants from plant rootstock and a plant trimming mechanism (20) adjacent the trailing end of the conveying means for trimming the plants.

### TECHNICAL FIELD

This invention relates to a method of and apparatus for harvesting standing vegetable crops and in a particular aspect to a method of and apparatus for harvesting broccoli or other similar vegetables.

### BACKGROUND ART

Common methods of broccoli harvesting normally involve the use a crew of workers who harvest the broccoli heads or flowers by hand. For this purpose, the workers are supported on opposite side of a vehicle which transports the workers along rows of broccoli plants and the workers then sever the stems of the plants and place the harvested broccoli heads onto a collection/conveying system which conveys the heads to a collection station. This method of harvesting is very labour intensive and as a result relatively costly.

Whilst a number harvesters are known in use for harvesting other vegetable crops, it has not been possible to adapt these harvesters for use in harvesting broccoli due to the varying nature of broccoli plants and difficultly in gripping and severing the broccoli heads from the plant stem. These difficulties are accentuated because of the manner in which broccoli is normally grown which is in twin rows on spaced beds in which broccoli seed is planted in the beds at spaced positions along each row. Planting in this manner is undertaken to ensure that the plants grow tall with elongated internodes and less dense leaf matter. When planted in this manner, access to these plants for both manual and machine harvesting purposes has proven difficult.

### SUMMARY OF THE INVENTION

The present invention aims to provide a method of and apparatus for harvesting broccoli or other standing vegetable crops. Other objects and advantages of the invention will become apparent from the following description.

The present invention thus provides in a first preferred aspect, apparatus for harvesting broccoli or other standing vegetable plants, said apparatus comprising:

a mobile frame adapted to be advanced along a row of plants to be harvested;

a plant gathering and transporting mechanism supported to the leading end of said mobile frame, said mechanism including conveying and gripping means for gripping the stems of respective said plants in turn as said mobile frame is advanced along said row and for conveying the gripped stems of said plants rearwardly relative to the direction of movement of said mobile frame,

a stem severing mechanism adjacent a leading end of said conveying and gripping means and adapted to sever the stems of said plants from plant rootstock to free said plants from the ground whilst being gripped by said conveying and gripping means; and

a plant trimming mechanism adjacent a trailing end of said conveying and gripping means for trimming said plants.

Preferably the conveying means comprise the gripping means. Most preferably the conveying means comprise opposing conveyors having respective conveyor runs adapted to cooperate with each other to grip the stems of plants therebetween. During movement from the stem severing mechanism, the stems of the plants remain gripped by the conveying means. Preferably the trimming mechanism operates to sever a further portion of the stem of the plants when held by the conveying means to free the heads or flowers of the plants. The trimming mechanism may also serve to sever leaves of the plant.

Suitably the opposing conveyors have complementary members respectively adapted to cooperate in the respective conveyor runs to grip the plant stems. The complementary members in one form may comprise a series of alternating loop and trough elements with the loops elements of each conveyor being complementary to and being adapted in the cooperating conveyor runs to nest within the trough elements of the opposing conveyor.

The opposing conveyors suitably comprise endless conveyors. The conveyors suitably comprise endless chains which carrying the loop and trough elements. The loop and trough elements of each conveyor are suitably defined by an endless belt which is of band-like form secured at spaced positions to the chain so as to be of a serpentine configuration and define the loop and trough elements. The chains are suitably supported about spaced sprockets.

In a particularly preferred form, the conveying means comprise a central conveyor and opposite side conveyors adapted to cooperate with the central conveyor to grip therebetween the stems of plants growing in a pair of rows on opposite sides of the central conveyor. Thus the central conveyor has opposite belt runs which are adapted to cooperate with runs of the respective side conveyors.

Preferably, means are provided for synchronising movement of the conveyors. The synchronizing means may comprise gearing between the sprockets of the chains of the respective conveyors which ensure that the belts move at the same speed. Preferably the conveyors are adapted to be driven at the ground speed of the mobile frame.

The stem severing mechanism suitably comprises a rotatable cutting disc on the lower side of the conveying means, the cutting disc extending across the path of movement of the stems gripped by the conveying means. The cutting disc suitably is positioned rearwardly from the leading end of the conveying and gripping means and is adapted to be driven at a greater rotational speed than the speed of movement of the conveying means. The cutting disc may be coupled by a transmission means to the conveying means to be driven thereby. The transmission means may comprise a gear transmission or chain and sprocket transmission. The cutting disc suitably rotates in the same direction of movement as the chain sprockets of the conveying means.

Preferably the cutting disc is mounted on one of the conveyors of the conveying means and is coupled to the one conveyor so as to be driven in rotation upon operation of the one conveyor, the cutting disc suitably extending towards the other conveyor to extend across the path of movement of plants conveyed by the conveying means.

As an alternative to a cutting disc, the severing mechanism may comprise other forms of severing device such as rotatable blades.

The trimming mechanism suitably comprises a trimming disc on the upper side of and at the rear of the conveying means, which is adapted to sever a further portion of the stem from the plant on the upper side of the conveying means whilst it is still being held between the cooperative conveyors. Drive means are suitably provided for rotatably driving the trimming disc. The drive means may comprise a motor such as an hydraulic motor for directly driving the trimming disc. Preferably the trimming disc is mounted on the one conveyor of the conveying means. Preferably the drive means also drives the one conveyor. Preferably the rear sprocket of the endless chain of the one conveyor is adapted to be coupled to the drive means so as to be driven thereby. The rear sprocket may be coaxial with the trimming disc. Preferably the rear sprocket and trimming disc are mounted on a drive shaft adapted to be coupled to the drive means so that the rear sprocket is driven with the trimming disc. The trimming mechanism as an alternative to being a cutting disc or discs may comprise other forms of severing means such as rotatable blades

Where the conveying means comprises a central conveyor and opposite side conveyors, a cutting disc and a trimming disc are mounted to each side conveyor with the cutting disc being mounted to the leading end of each side conveyor and the trimming disc being mounted to the trailing end of each side conveyor. Preferably a pair of drive means such as hydraulic motors are suitably provided to drive the trimming discs sprockets of the respective side conveyors. The trimming discs of the respective side conveyors are suitably driven in contra-rotation by the drive means

Preferably also the drive means is adapted to drive the side conveyors suitably through the rear sprockets of the respective side conveyors. Preferably transmission means are provided between the side conveyors and central conveyor to enable the central conveyor to be driven by the drive means.

A first transfer conveyor is suitably provided adjacent the trailing end of the conveying and gripping means to receive the plants from the trimming mechanism, the first conveyor extending transversely of the mobile frame. Preferably a rotatable paddle means are is provided to assist in moving the plants from the trimming mechanism onto the first conveyor.

Elevating conveyor means are preferably provided for receiving the plants from the first transfer conveyor for elevating the harvested plants for collection. An air blower is suitably provided at the upper end of the elevating conveyor means for blowing air through the harvested plants to blow leaf matter therefrom.

The harvester may include an upper collection station and further conveyor means are suitably provided for receiving plants from the elevating conveyor means and transferring the plants to the collection station. A delivery conveying means may extend to one side of the mobile frame for delivery of the heads of the harvested plans to a bin for example driven alongside the mobile frame.

In another aspect, the present invention provides a method for harvesting broccoli or other standing vegetable plants using a mobile harvester, said method including the steps of gripping the stems of respective said plants as said harvester moves along a row of said plants, severing said gripped stems from the rootstock of said plants, conveying said plants severed from said rootstock rearwardly relative to the direction of movement of said mobile harvester and trimming and severing the heads from said conveyed plants.

In yet a further aspect, the present invention provides a harvesting head for harvesting broccoli or other standing vegetable plants growing in a row, said harvesting head comprising:

plant gripping means for gripping in turn the stems of respective said plants in said row,

a stem severing mechanism adapted to sever the stems of said plants from plant rootstock to free said plants from the ground whilst being gripped by said plant gripping means;

and conveying means for conveying plants gripped by their stems rearwardly from said stem severing means.

The harvesting head suitably includes a plant trimming mechanism for trimming the plants conveyed by the conveying means. Suitably the plant trimming mechanism is adapted to sever further stem and/or leaf material from the plants.

The plant gripping means suitably comprises the conveying means, the conveying means suitably comprising a pair of opposing conveyor belts having adjacent runs adapted to grip said plant stems therebetween. The belts suitably are of serpentine configuration and have a plurality of alternating loop and trough elements, the loop elements of each belt being complementary to said trough elements of the opposing belt. Suitably the severing mechanism is on the lower side of the conveying means and the trimming mechanism is on the upper side of the conveying means.

### BRIEF DESCRIPTION OF THE DRAWINGS

In order that the invention may be more readily understood and put into practical effect, reference will now be made to the accompanying drawings which illustrate a preferred embodiment of the invention and wherein:—

FIG. 1 is a side view of a harvester according to an embodiment of the invention designed primarily for harvesting broccoli;

FIG. 2 is an isometric view from the rear of the harvester of FIG. 1;

FIG. 3 is a partly cut away isometric view of the harvester of FIG. 1;

FIG. 4 illustrates in isometric view, the harvesting head assembly of the harvester of FIGS. 1 to 3;

FIG. 5 is a top view of the harvesting head assembly of FIG. 4;

FIG. 6 illustrates in isometric view of one of the harvesting heads of the harvesting head assembly of FIGS. 4 and 5;

FIGS. 7 and 8 are top and bottom views of the harvesting head of FIG. 6; and

FIGS. 9 and 10 illustrate in top and side views the manner in which broccoli plants are harvested using the harvester.

### DETAILED DESCRIPTION OF THE PREFERRED EMBODIMENT

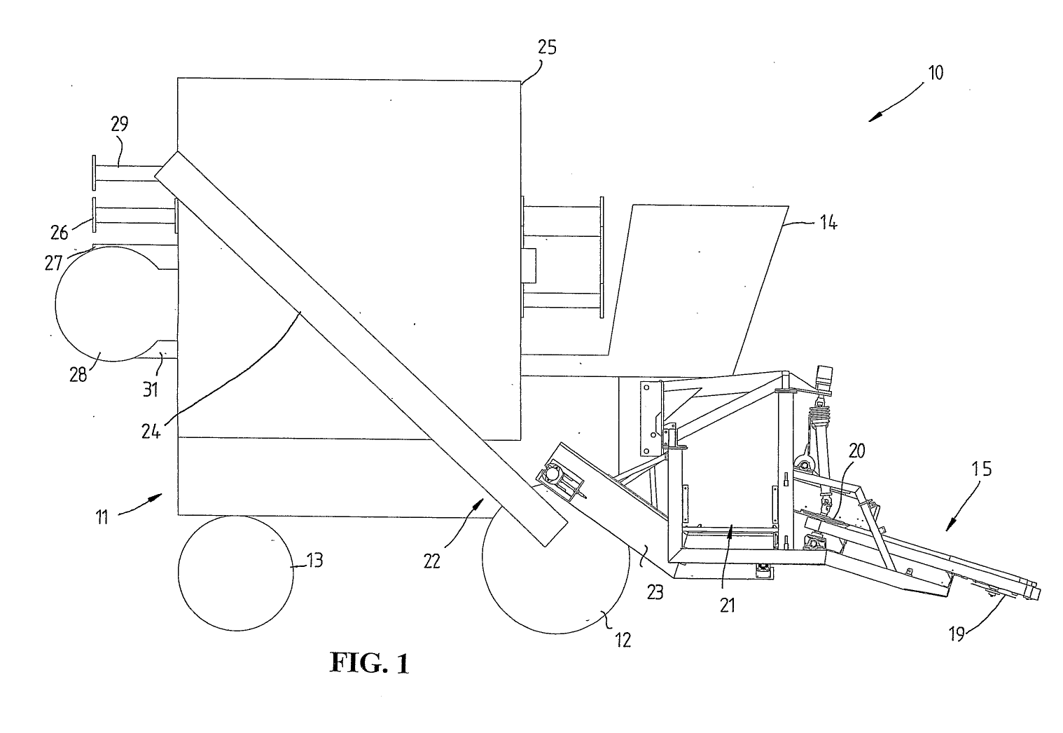

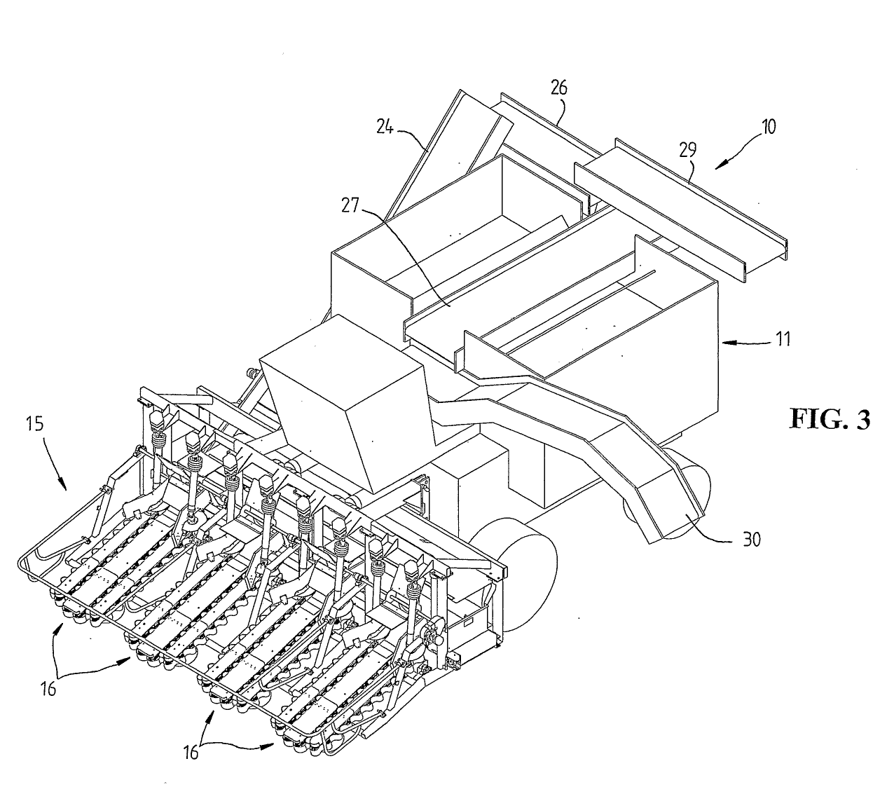

Referring to the drawings and firstly to FIGS. 1 to 3, there is illustrated a harvester 10 according to an embodiment of the invention comprising a self powered mobile frame or vehicle 11 supported by front and rear sets of wheels 12 and 13, the front wheels 13 comprising drive wheels of the vehicle 11 which are capable of being driven by an engine typically an internal combustion engine on the vehicle 11 and the rear wheels 13 being steerable wheels. The vehicle 11 includes an operator cabin 14 which can house an operator and from which the vehicle 11 may be driven and operated and from which the harvesting operations may be controlled. The harvester 10 is designed for harvesting broccoli grown in twin rows typically spaced 25.4 cm apart on spaced beds typically placed 1 m apart with broccoli seed planted in the parallel beds at spaced positions along each row typically at 8-9 cm intervals.

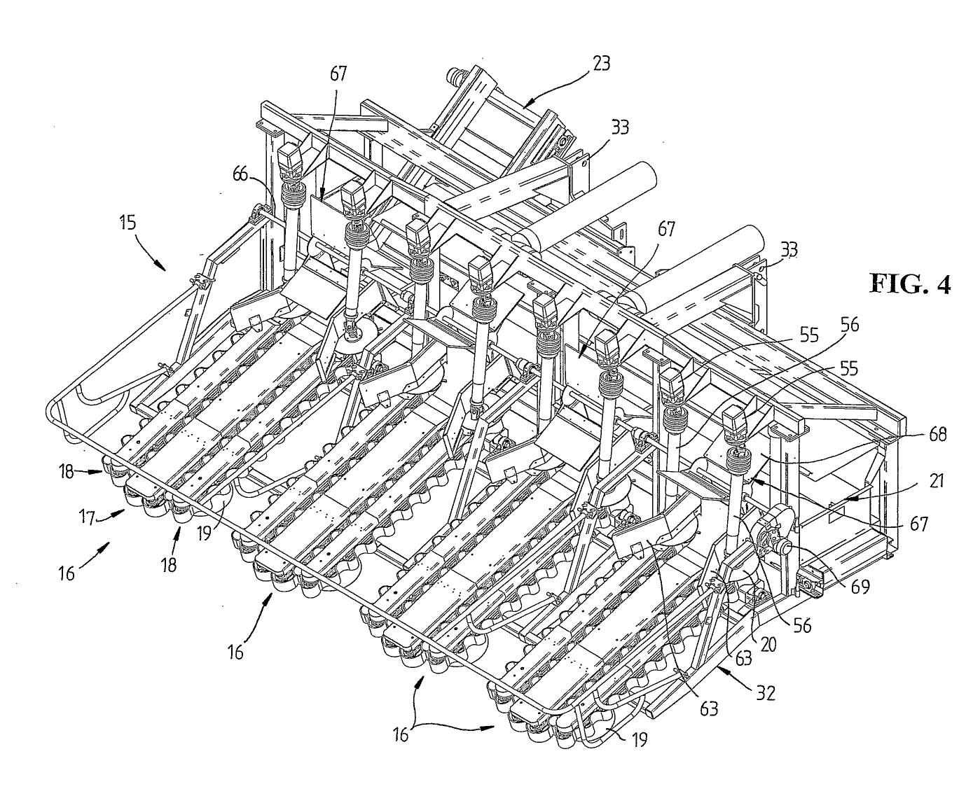

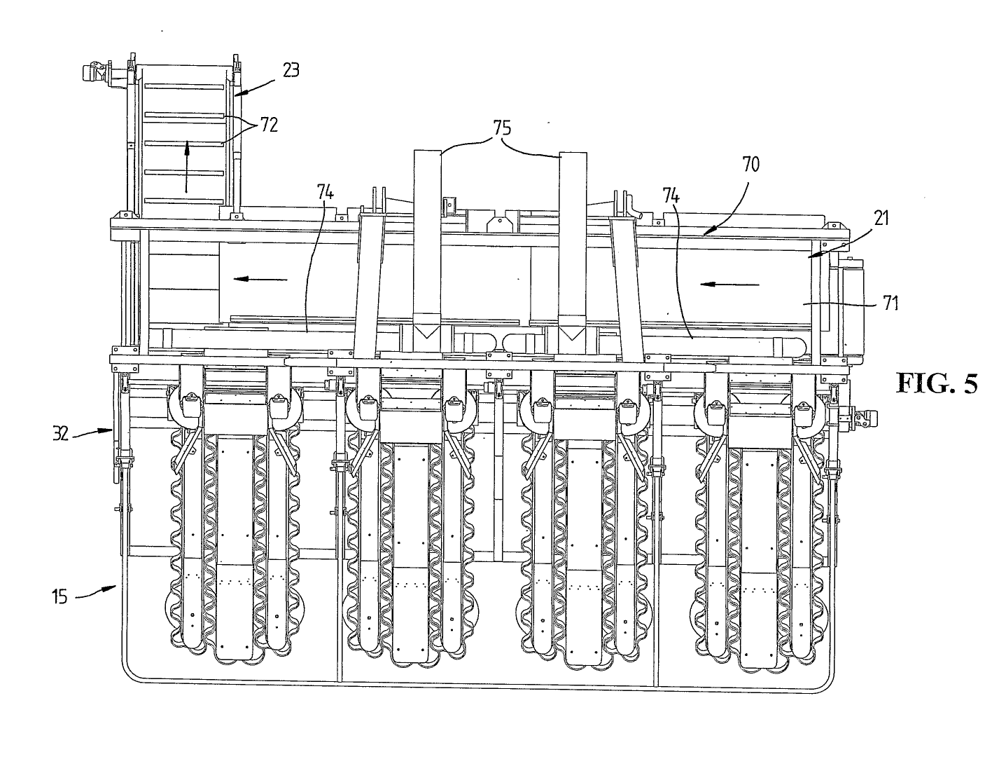

Supported to the vehicle 11 is a harvesting head assembly 15 (see also FIGS. 4 and 5) which extends forwardly of the vehicle 11 in a cantilever manner, the harvesting head assembly 15 including in this embodiment four harvesting heads 16, each comprising a central conveyer 17 which is positioned to pass in use between the two rows of broccoli plants and two side conveyers 18 which pass respectively to the outside the respective rows of broccoli plants and which are adapted to cooperate with the central conveyor 17 .

A first cutter 19 is provided at the forward end of each side conveyor 18 to sever the stems of the broccoli plants from the rootstock. A second trimming cutter 20 is proved at the rear end of each side conveyor 18 to trim the stem and leaf of plants conveyed by the cooperating conveyers 17 and 18 from the cutters 19.

A transversely extending conveyor 21 is supported on the vehicle 11 at the rear of and lower than the rear end of the conveyors 17 and 18 to receive the trimmed plants from the cutters 20 and convey the plants to one side of the vehicle 11 for deposit onto an elevating conveyor assembly 22.

The elevating conveyor assembly 22 comprises a first lower conveyor 23 and a second upper conveyor 24 which extend along one side of a final enclosed crop handing station 25 which is supported on the vehicle 11. A further transverse conveyor 26 is positioned at the rear of the station 25 to receive the harvested plants from the upper conveyor 24 to transfer the plants across the rear of the vehicle 11 for deposit onto an upper longitudinally extending conveyor 27 which conveys the crop into the enclosed station 25 for final leaf separation by hand. A blower 28 provided at the rear of the station 25 adjacent the upper end of the conveyor 24 blows air through the harvested plants as they pass from the upper conveyor 24 to the further transverse conveyor 26. A second leaf collection conveyor 29 is positioned at the rear of the station 25 above the conveyor 26. The conveyor 29 extends transversely to the side of the vehicle 11 opposite the elevating conveyor assembly 22 and collects leaf matter blown from the blower 28 through plants on the conveyor 26 or transferred from the upper conveyor 24. This leaf matter is directed back onto the ground.

Within the station 25, trash and loose leaves are removed from the broccoli heads by hand and the heads are deposited onto a further adjustable conveyor 30 which extends transversely to the side of the vehicle 11 for deposit into a mobile bin or the like driven alongside the harvester 10. A further longitudinally extending conveyor 31 extending to the rear of the harvester 10 is used to convey the trash and loose leaves separated from the heads on the conveyor 27 to the rear of the harvester 10 for collection in a bin or the like trailed from the harvester 10.

The harvesting head assembly 15 as shown in FIGS. 4 and 5 includes a main frame 32 which is mounted to the leading end of the vehicle 11 so as to extend transversely thereof, the main frame 32 supporting the four harvesting heads 16 arranged at a transverse spacing across the frame 32 corresponding to the spacing of pairs of rows of broccoli to be harvested. The support frame 32 also supports at the rear of the harvesting heads 16, the transversely extending transfer conveyor 21. The lower end of the elevating conveyor 23 is supported at one end of the transfer conveyor 21. The frame 32 is mounted to the vehicle 11 by hydraulic rams (not shown) connected to frame mounts 33 which can selectively raise, lower and tilt the frame 32 and associated harvesting heads 16 to adjust the height at which the crop is cut above the ground.

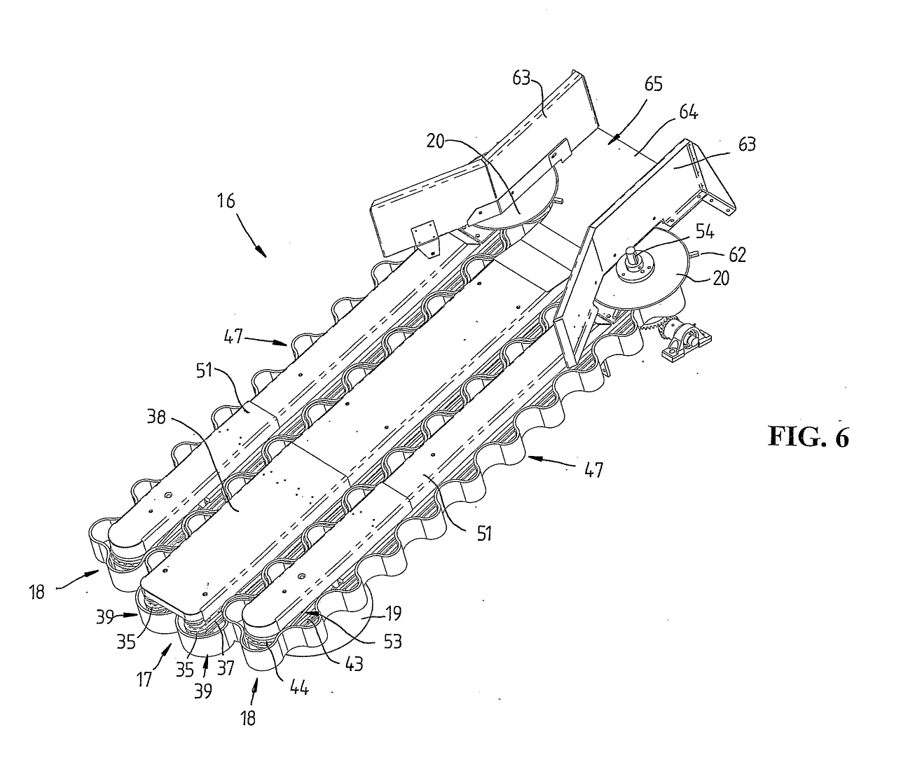

Each harvesting head 16 as shown more clearly in FIGS. 6 to 8 and as referred to above includes the central conveyor 17 and opposite side conveyors 18 which extend parallel to the central conveyor 17 and the severing and trimming disc cutters 19 and 20 at opposite ends of the respective side conveyors 18 and positioned below and above each conveyor 18 respectively. The central conveyor 17 comprises a pair of elongated support arms 34 each of which carries a pair of bearing mounted spaced sprockets 35 and 36 at opposite ends end which support a pair of endless chains 37 respectively which extend substantially parallel to each other. The arms 34 are secured to upper elongated cover plates 38 which holds the arms 33 substantially parallel to each other. Respective elongated endless flexible band-like belts 39 which are of a greater length than the chains 37 extend around each chain 37 and are fixed to links of the chain 37 at a series of regularly spaced fixing positions 40 so as to form the belt 39 into a serpentine sine-wave like configuration comprising series of alternating convex loops and concave troughs 41 and 42 with the belt 39 secured to the chain 37 within the troughs 41. The belts 39 are fixed to links of the respective chains 35 by any suitable brackets and fasteners (in this case rivets). The loops and troughs 41 and 42 of the pair of belts 39 connected to each chain 37 interlock adjacent runs of the belts 39 with the loops 41 of one belt 39 being received in the troughs 42 of the other belt 39. The two looped belts 39 define along opposite sides of the conveyor 17 belt runs which move concurrently in use.

The side conveyors 18 are of a similar construction to the central conveyor 17 except that each includes only a single endless chain 43 extending around enlarged sprockets 44 and 45 mounted at opposite ends of a support arm 46, the chain 43 also carrying an endless flexible belt 47 secured to spaced links of the chain 43 at spaced fixing positions 48 in a similar manner to that described above to form the belt 47 into a sine-wave like serpentine configuration comprising a further series of convex loops 49 and concave troughs 50 between spaced fixing positions 48. The fixing positions 48 are spaced apart the same distance as the fixing positions 40 of the belt 39 and the length of the belts 39 and 47 between the fixing positions 40 and 48 is substantially the same so that the loops and troughs in each belt 39 and 47 are substantially the same. The arms 46 of the side conveyors 18 are also covered by top covers 51.

The side conveyors 18 are positioned relative to the central conveyor 17 such that the belt loops 49 and troughs 50 of the side conveyors 18 are complementary to and interlock in adjacent belt runs with the belt troughs 42 and loops 41 of the central conveyor 17. Thus the convex loops 41 of the respective belts 39 of the conveyor 17 nest within the concave troughs 50 of the belts 47 of the side conveyors 18 in the belt runs on opposite sides of the conveyor 17 and similarly the convex loops 49 of the belts 47 nest within the concave troughs 42 of the belts 39.

Each support arm 46 of the side conveyor 18 also carries the cutting disc 19 which is supported on a bearing mounted shaft 52 to the underside of the arm 46 for rotation about an axis parallel to the axis of rotation of the sprockets 43. The cutting disc 19 supported on the shaft 52 however is positioned rearwardly of the leading chain sprocket 44 and is connected to the chain sprocket 44 through a chain sprocket transmission 53 comprising a sprocket on the shaft 52 fixed for movement with the disc 19 and a further sprocket fixed for movement with the sprocket 44 and a chain therebetween with the transmission ratio of the transmission 53 being such that the cutting disc 19 rotates at a greater rotational speed than the sprocket 44. The cutting discs 19 are located adjacent to but on the lower side of the belts 39 and 47 and have a diameter such as to extend across the junction between the cooperable runs of the belts 39 and 47 or “nips” between the conveyors 17 and 18.

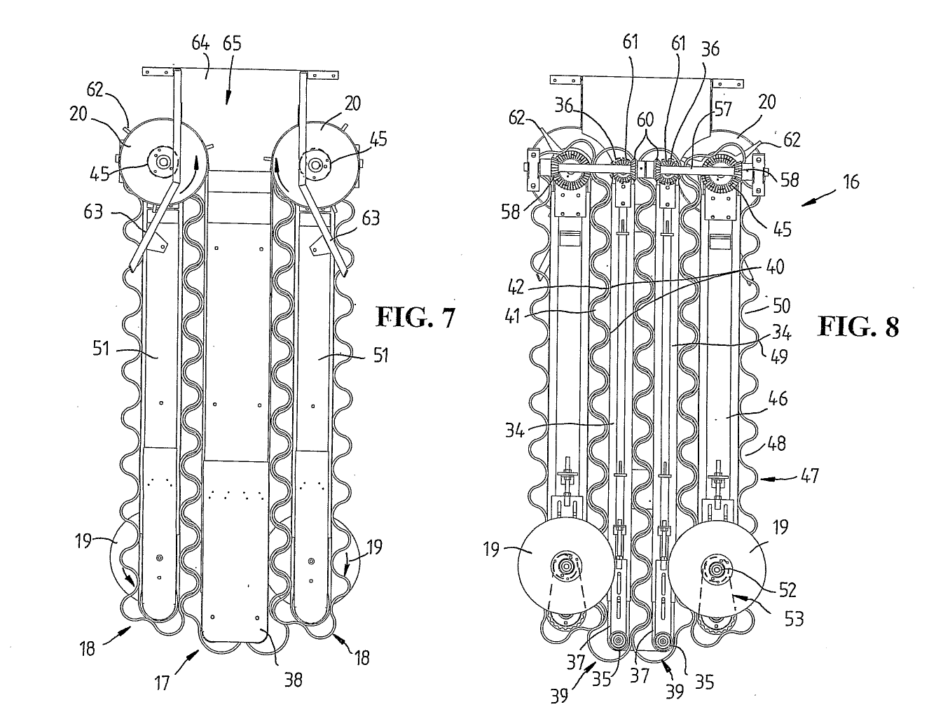

Each trimming cutter disc 20 is keyed to a shaft 54 mounted in bearings at the trailing end of each conveyor support arm 46, the shaft 54 being parallel to the disc shaft 52 and the disc 20 being positioned above the conveyor 18 but adjacent to the belt 47. Additionally keyed to the shaft 54 for rotation therewith is the rear sprocket 45 of the conveyor 18 such that the sprocket 45 is coaxial with the disc 20. Respective hydraulic motors 55 are mounted on the frame 32 above the discs 20 of the harvesting head 16 and are adapted to be coupled to the disc shafts 54 via universal shafts 56 to drive the shafts 54 in contra-rotation as indicated in the arrows of FIG. 7. Both the severing discs 19 and trimming discs 20 may be serrated cutting discs.

For driving of the conveyors 17 and 18 of a harvesting head 16, a transverse drive shaft 57 is provided at the rear of the head 16 and carries bevel gears 58 meshing with bevel gears 59 fixed for rotation with the disc shaft 54. Further bevel gears 60 fixed to the shaft 54 mesh with gears 61 fixed for rotation with the rear sprockets 36 of the conveyor17. The gears 60 and 61 having a 1:1 ratio however the ratio of gearing between the bevel gears 58 and 59 provides a step down gearing between rotation of the shaft 54 and thus rotation of the rear sprockets 45 of the conveyors 18. This ensures that the chains 37 and 43 and belts 39 and 47 move at the same speed thus maintaining synchronised movement of the loops and troughs of the belts 39 and 47 to maintain the interlocking relationship therebetween.

The trimming discs 20 rotate at the same speed as the chain sprockets 45 and thus have the same speed of movement as the belts 39 and 47. The trimming discs 20 are further of a diameter to extend across the junction between runs of the respective belts 39 and 47. Provided on the underside of the discs 20 are radially extending wiper arms 62 which extend beyond the periphery of the discs 20 and help to clear the waste material under the discs 20 onto the ground beneath the harvester 10.

For guiding the harvested crop onto the conveyor 21, fixed upright guide members 63 are mounted at a transverse spacing to the rear end of the respective side conveyors 18 and extend on opposite sides of a rear platform 64 to define a throat-like passage 65 through which the crop is directed to the rear. In addition, an elongated shaft 66 is supported rotatably in bearings above the harvesting heads 16 and extends transversely of the harvesting head assembly 15 above the passages 65. The shaft carries respective rotatable “paddle” wheels 67, each of which includes radially extending vane-like paddles 68 which are aligned with respective passages 65. The shaft 66 is coupled at one end through a gearbox to a drive motor 69. Rotation of the paddles 67 when driven by the drive motor will assist in moving the trimmed and severed broccoli heads from the trimming discs 20 onto the transverse conveyor 21. The paddles 68 are in the form of flexible planar elements formed for example of rubber which are free at their outer ends and which are secured at their inner ends for movement with the shaft 60.

The transverse conveyor 21 comprises an elongated trough 70 and an endless belt 71 which is supported in the trough 70 and which is driven in one direction as indicated by the arrows in FIG. 5 to direct the crop towards the conveyor 23. The conveyor 23 includes a series of transverse flights 72 to assist in elevating the harvested crop.

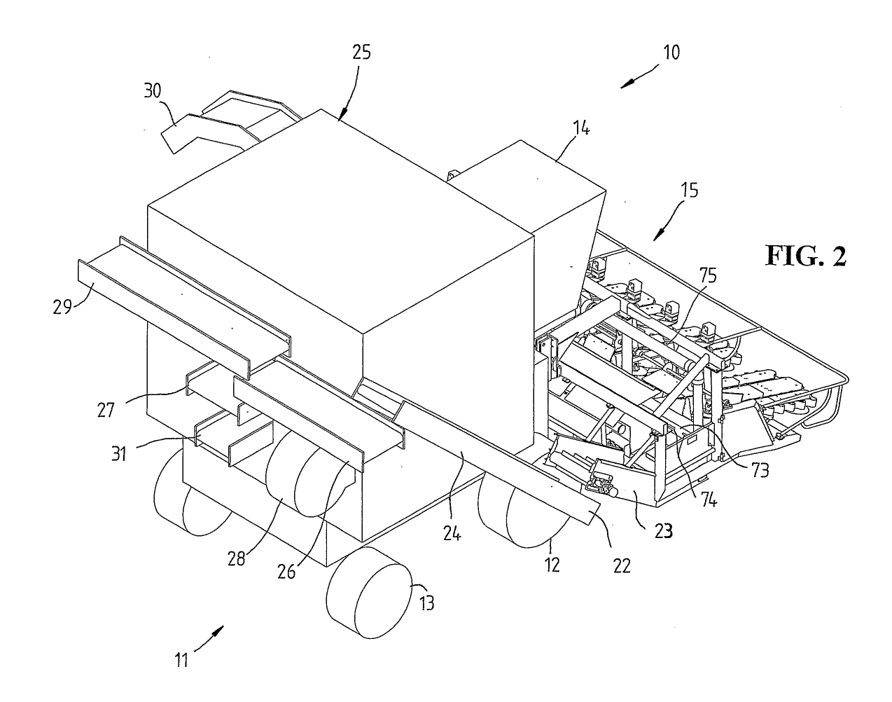

To assist in removing cut leaves and trash from the conveyor 21, air pipes 73 extend along one or both sides of the conveyor 21 (see FIG. 2), the air pipes 73 having slots or other outlets 74 through which air can exit. The pipes 73 are supplied with air from air manifolds 74 (see FIG. 5) which are connected by air pipes 75 to air pumps (not shown) driving from the engine of the vehicle 11. Air exiting the outlets 74 is blown across the conveyor 21 to blow light materials such as leaves from the conveyor 21 to prevent them being passed onto the conveyor 23.

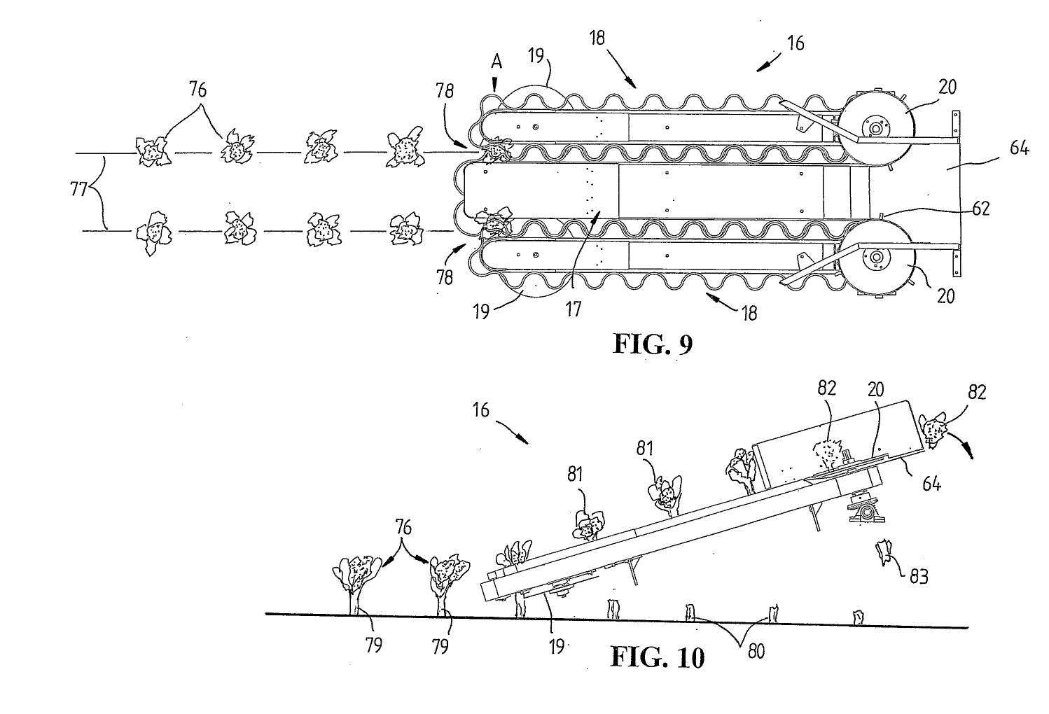

As shown in FIGS. 9 and 10, the harvester 10 is designed primarily for harvesting broccoli plants 76 growing in spaced apart positions in pairs of rows 77, only one pair of which are shown. The harvester 10 in this embodiment includes four harvesting heads 16 and thus is capable of harvesting broccoli growing in four pairs of rows. The harvester 19 is positioned so that each harvesting head 16 is aligned with a pair of rows 77 with the “nips” 78 between the belts 47 and 39 of the side conveyors 18 and central conveyor 17 being aligned with the respective rows 77 of a pair of rows. The frame 32 is lowered to an appropriate height at which the stems 79 of the broccoli plants 76 are to be severed. The harvester 10 is then advanced along the rows 77 and the conveyors 17 and 18 driven by the drive motors 55 such that they operate at a speed equal to the ground speed of the harvester 10. The motors 55 of the respective harvesting heads 16 are hydraulically connected to ensure that the conveyors 17 and 18 of the respective heads 16 are driven at the same speed and operate in synchronism.

Initially, the stems 79 of the broccoli plants in the rows 77 will enter the nips between the belts 39 and 47 and be gripped one after the other between the opposing complementary loops and troughs of the conveyor belts 39 and 47 as they move into cooperative engagement with each other as for example indicated at A in FIGS. 9 and 10. The loops and troughs will usually deflect to accommodate and grip the stems 79. The stems 79 will thus be firmly held between the belts 39 and 47 in an upright position as shown in FIG. 10 as they are move relatively towards the cutting discs 19 as the harvester 10 advances. The stems 70 thus do not move significantly relative to the ground as the belts 39 and 47 are moving at the ground speed of the harvester 10. As the stems 79 contact the edge of the rotating cutting discs 19 which are rotating at a higher speed than the speed of movement of the belts 39 and 47, the stems 79 are severed by the discs 19 from the rootstock 80 which remain in the ground. After the stems 79 are severed from the root stock, the severed plant 81 including some of the leaf material will be continued to be gripped between the loops and troughs of the cooperating conveyors 39 and 47 and supported in an upstanding attitude and conveyed rearwardly by the conveyors 39 and 47 until they reach the trimming discs 20. The heads 82 of the broccoli plants one after the other are then severed by the discs 20 from the remaining stem parts 83 held between the conveyors 17 and 18. At the end of the conveyors 17 and 18, the remaining stem parts 83 will drop to the ground where the cooperable belt loops and troughs move away from each other. Similarly trimmed leaf material will drop to the ground. This is also assisted by the rotating wiper arms 62 on the underside of the discs 10. The heads 82 will pass onto the platform 64 and the rotating paddles 67 will move the heads 82 onto the transverse conveyor 21.

The harvested broccoli heads 82 which are now loose on top of the conveyor belt 71 are moved towards the lower elevating conveyor 23 upon which they are deposited. Any loose leaf or trash on the conveyor belt 71 is blows from the belt by the air exiting the air outlets 74 of the air pipes 73. The broccoli heads 82 are then elevated and deposited onto the second upper elevating conveyor 24 to carry them upwards to the top for deposit onto transverse conveyor 26 with an air blast from the blower 27 blowing through the heads as they drop from the conveyor 24 onto the conveyor 26 to remove any loose leaf and debris that has been conveyed with the broccoli heads, that material being directed onto the conveyor 29 where it is directed back onto the ground. The “cleaned” broccoli heads are then deposited onto the conveyor 27 where they are conveyed into the station 25 for final leaf or trash removal and sorting. The finally cleaned broccoli heads then pass from the conveyor 27 onto the conveyor 31 where the broccoli heads are directed to a bin driven alongside the harvester. Any loose leaves or other trash is placed by hand on the conveyor 31 to be directed to the rear of the harvester where this material may be collected in a bin towed by the harvester 10.

Whilst the embodiment has been described with reference to the harvesting of broccoli plants, it will be appreciated that the invention may be applied to the harvesting of other forms of standing crops. Furthermore, the severing and trimming mechanisms of the harvester may be in forms other than described above. In addition, various different arrangements other than the conveying arrangements described may be used for conveying the harvested plants to a collection station.

The cooperating conveyors 17 and 18 of each harvesting head 16 may be in different configurations than that described. For example, the belts rather than being in the serpentine loop/trough configuration may be provided with a series of resiliently compressible pads which can cooperate with each other to grip the plant stems therebetween. Further whilst the central conveyor 17 is described to include two belts, it may comprise a single belt and single chain supported about spaced sprockets.

The belts 39 and 47 as referred to above are band-like belts formed of rubber or other flexible material and typically may have a width of about 100 mm although this may vary.

The terms “comprising” or “comprises” as used throughout the specification and claims are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as herein defined in the appended claims.

1-26. (canceled)

27. Apparatus for harvesting broccoli or other standing vegetable plants, said apparatus comprising:
a mobile frame adapted to be advanced along a row of plants to be harvested;
a plant gathering and transporting mechanism supported to the leading end of said mobile frame, said mechanism including conveying and gripping means for gripping the stems of respective said plants in turn as said mobile frame is advanced along said row and for conveying the gripped stems of said plants rearwardly relative to the direction of movement of said mobile frame,
a stem severing mechanism adjacent a leading end of said conveying and gripping means and adapted to sever the stems of said plants from plant rootstock to free said plants from the ground whilst being gripped by said conveying and gripping means; and
a plant trimming mechanism adjacent a trailing end of said conveying and gripping means for trimming said plants.

28. Apparatus as claimed in claim 27 wherein said conveying means comprise the gripping means.

29. Apparatus as claimed in claim 28 wherein said conveying means comprise opposing conveyors having respective conveyor runs adapted to cooperate with each other to grip the stems of plants therebetween.

30. Apparatus as claimed in claim 29 wherein said opposing conveyors have complementary members respectively adapted to cooperate in the respective conveyor runs to grip said plant stems.

31. Apparatus as claimed in claim 30 wherein said complementary members comprise a series of alternating loop and trough elements with the loops elements of each conveyor being complementary to and being adapted in said cooperating conveyor runs to nest within the trough elements of the opposing conveyor.

32. Apparatus as claimed in claim 31 wherein said opposing conveyors comprise endless chains which carrying the loop and trough elements.

33. Apparatus as claimed in claim 32 wherein said loop and trough elements of each conveyor are defined by an endless belt secured at spaced positions to the chain so as to be of a serpentine configuration and define said loop and trough elements.

35. Apparatus as claimed in claim 33 wherein said conveying means comprise a central conveyor and opposite side conveyors adapted to cooperate with said central conveyor to grip therebetween the stems of plants growing in a pair of rows on opposite sides of said central conveyor.

36. Apparatus as claimed in claim 38 and including means for synchronising movement of said conveyors.

37. Apparatus as claimed in claim 29 wherein said conveyors are adapted to be driven at the ground speed of said mobile frame.

38. Apparatus as claimed in claim 29 wherein said stem severing mechanism comprises a rotatable cutting disc on the lower side of said conveying means, said cutting disc extending across the path of movement of said stems gripped by said conveying means.

39. Apparatus as claimed in claim 38 wherein said cutting disc is positioned rearwardly from the leading end of said conveying and gripping means and is adapted to be driven at a greater rotational speed than the speed of movement of said conveying means.

40. Apparatus as claimed in claim 39 wherein said cutting disc is coupled by a transmission means to said conveying means to be driven thereby.

41. Apparatus as claimed in claim 29 wherein said trimming mechanism comprises a trimming disc on the upper side of said conveying means and including drive means for rotatably driving said trimming disc.

42. Apparatus as claimed in claim 41 wherein said conveying means are coupled to said drive means and are adapted to be driven thereby.

43. Apparatus as claimed in claim 27 wherein a first transfer conveyor is provided adjacent the trailing end of the conveying and gripping means to receive the plants, said first conveyor extending transversely of the mobile frame.

44. Apparatus as claimed in claim 43 and including elevating conveyor means for receiving the plants from the first transfer conveyor for elevate the harvested plants for collection.

45. Apparatus as claimed in claim 44 and including an air blower at the upper end of the elevating conveyor means for blowing air through the harvested plants to blow leaf matter therefrom.

46. Apparatus as claimed in claim 45 and including an upper collection station and there being provided further conveyor means for receiving plants from said elevating conveyor means and transferring said plants to said collection station.
